(19) United States
(12) Patent Application Publication
(10) Pub. No.: US 2017/0053255 A1
(43) Pub. Date: Feb. 23, 2017

(54) FINANCIAL INTERMEDIARY FOR ELECTRONIC HEALTH CLAIMS PROCESSING

(71) Applicant: Humana Inc., Louisville, KY (US)

(72) Inventor: Dennis Hillen, Prospect, KY (US)

(21) Appl. No.: 15/343,607

(22) Filed: Nov. 4, 2016

Related U.S. Application Data
(63) Continuation of application No. 13/603,103, filed on Sep. 4, 2012.
(60) Provisional application No. 61/530,654, filed on Sep. 2, 2011.

(51) Int. Cl. G06Q 20/14; G06F 19/00

(52) U.S. Cl. CPC G06Q 20/14; G06F 19/328

(57) ABSTRACT

A financial intermediary for electronic health claims processing is disclosed. The financial intermediary provides consolidated billing of healthcare provider charges for consumers. Consumers receive from the financial intermediary one itemized statement that provides a clear and aggregated view of past medical events and charges from one or more healthcare providers. The statement clearly identifies the consumer's financial responsibility to the healthcare providers and a total amount owed to the providers. The consumer sends a single payment to the financial intermediary and the financial intermediary pays the healthcare providers. In one embodiment, medical events may be organized on the statement according to episodes of care. An episode of care identifier is assigned at the time of provider billing so that charges on a consolidated statement may be organized according to the identifiers. When the statement is generated, the charges are grouped according to identifiers for episodes of care.

### CROSS-REFERENCE TO RELATED APPLICATIONS

This application is a continuation of U.S. application Ser. No. 13/603,103, filed Sep. 4, 2012, which claims priority to U.S. Provisional Application No. 61/530,654, entitled FINANCIAL INTERMEDIARY FOR ELECTRONIC HEALTH CLAIMS PROCESSING and filed Sep. 2, 2011, the contents of each of which are hereby incorporated by reference in their entirety.

### BACKGROUND

Although consumers benefit in many ways from healthcare insurance plans for coverage of their healthcare costs, there are aspects of the health plans and plan administration that are very difficult for consumers to understand. One difficulty many consumers often have is understanding their own financial responsibility under the plans and the total cost of care on the system. Under many health plans, the consumer is responsible for a co-payment for every doctor office visit as well as every prescription or medication. The consumer may have additional financial responsibility for a deductible under the plan and/or a percentage of service costs under a coinsurance provision. Additionally, the consumer may be responsible for unreimbursable fees or charges (e.g., if the provider's fee exceeds a reimbursable amount under the plan or if a service is not reimbursable under the plan).

The consumer is typically responsible for the co-payment at the time of service. Therefore, before leaving the facility at which the service is provided (e.g., doctor's office or pharmacy), the consumer pays the healthcare provider the amount of the co-payment with cash, a check, or a credit card. The consumer's additional financial responsibility is determined following adjustment and adjudication of a claim submitted to the insurer. The outcome of the adjustment and adjudication is reported to the consumer in an explanation of benefits report (EOB) that typically provides details such as health plan identifying information, the insured, the patient, the date of service, the provider, the specific service, the total provider charges, and the amount paid to the provider. If all or a portion of the claim was denied, the EOB explains why the claim was denied. If the consumer is responsible for any portion of the provider charges, the amount is also noted.

The EOB typically reflects the flow of provider claims through the insurer's claims processing system. For the consumer, a single episode of care may involve multiple visits to a doctor's office and/or a hospital or other healthcare facility. Additionally, several medications may be prescribed. Every service and prescription results in a provider invoice that is submitted with a claim to the insurer. Each claim is adjusted and adjudicated separately, typically in the order received from the providers. Depending upon when each claim is received and processed by the insurer and the insurer's schedule for generating EOBs, the consumer may receive several EOBs over the course of several weeks or months, all related to a single episode of care. Because the consumer does not know how and when the provider will send invoices and submit claims for services, the consumer is never certain whether all of the claims related to the episode of care have been submitted by the providers. The consumer may continue to receive EOBs long after the health-related episode occurred.

Although consumers receive detailed EOBs that explain the benefit payments made to healthcare providers, many consumers find them to be more confusing than helpful. The top of the report may have a statement that reads “EXPLANATION OF BENEFIT PAYMENTS. THIS IS NOT A BILL.” The report then has several columns of numbers, one of which is labeled “Your Balance.” If the amount in the “Your Balance” column is greater than zero, the consumer is left with the impression he or she is responsible for some of the charges but is not actually being billed for them. If the consumer does not have a corresponding provider invoice for the same amount shown in the EOB, the consumer may be uncertain about how and when the provider should be paid. Furthermore, the consumer has no way of knowing whether the provider has submitted or will be submitting additional claims that the insurer will ultimately pay thereby reducing the consumer's financial obligations.

If the provider's claim is denied in part or in full and the consumer is responsible for part or all of the charges, the provider typically sends an invoice to the consumer. In many instances, the invoice is sent long after the service was provided. It may not be clear from the provider's invoice, how the invoice charges relate to the claim or claims that were submitted to the insurer and that appear on the EOB. If the amount on the provider invoice does not match the “Your Balance” amounts on the EOB, the consumer may be confused about what the provider is actually owed. The consumer may further wonder whether all claims for all services have been submitted and/or processed and whether a payment should be made to the provider.

For consumers, the disparate and cryptic financial communications they receive from insurers as well as healthcare providers often lead to confusion about what they owe and to whom. EOBs are not intuitive or actionable and their relationship to healthcare provider invoices is often unclear. Consumers often need to devote time and resources to communicating with the insurer and their healthcare providers to determine what they actually owe to each provider. If consumers misunderstand what they owe and fail to pay providers as required under their health plans, the consequences can be devastating. Their credit scores are at risk and may be impacted by their failure to pay their healthcare providers. For families dealing with sickness, the current system creates additional financial stress at the worst possible time.

Determining what is owed to healthcare providers is even more complex for consumers that have one or more dependents and that are financially responsible for uncovered medical charges and expenses for one or more dependents. The financially responsible consumer may be not be directly involved in every aspect of the dependent's routine care or may be not aware of certain care or services the dependent has received for urgent or critical conditions. EOBs as well as healthcare provider statements present information about services that have been provided but they are typically directed specifically to the financially responsible party and organized according to date of service. As a result, items for different covered patients appear on a single statement in chronological order making it difficult for the consumer to determine what services were performed for each covered patient and the total charges attributable to each covered patient. The consumer is left with uncertainty about what is owed and to whom.

Healthcare providers are also negatively impacted by current financial responsibility arrangements between insurers and consumers. Providers incur costs and administrative overhead associated with managing billing and collection capabilities. In addition to providing healthcare services, they must be adept at submitting claims for reimbursement and at managing cash flow and collections from consumers. Because healthcare providers have patients covered by numerous plans with different levels of benefits, they are also frequently confused about which charges are the responsibility of the insurer and which charges are the responsibility of the consumer. Therefore, their billing and collection practices must include tracking of payments from insurers as well as consumers.

There is a need for an improved system and method for electronic health claims processing and payment. There is a need for an improved system and method for electronic health claims processing and payment that addresses the concerns of consumers, and in particular, consumers that are financially responsible for one or more dependents. There is also a need for an improved system and method for electronic health claims processing and payment that addresses the concerns of healthcare providers, and in particular, that supports prompt payment and reduces overhead associated with collections. There is also a need for an improved system and method for electronic health claims processing that provides a single point of contact for financial aspects of healthcare services. There is a need for a financial intermediary that facilitates electronic health claims processing, that generates consolidated billing statements for healthcare service charges, and that receives and processes consumer payments to healthcare providers.

### SUMMARY OF THE INVENTION

The present disclosure is directed to a financial intermediary for electronic health claims processing that provides consolidated billing of healthcare provider charges for consumers. In an example embodiment, consumers receive from the financial intermediary one itemized statement a month that provides a clear and aggregated view of past medical events or services and charges from one or more healthcare providers. The statement clearly identifies the consumer's financial responsibility to each healthcare provider and a total amount owed to the providers for services not reimbursed under their health plans. The consumer sends a single payment to the financial intermediary and the financial intermediary then pays each healthcare provider. Provider charges are consolidated on the monthly statement making monitoring and management of costs easier and more convenient for consumers. Multiple EOBs are aggregated and bills from various healthcare providers and vendors are compiled into a single, easy-to-understand statement.

In one example embodiment, medical events may be organized on the statement according to episodes of care. An episode of care identifier is assigned at the time of healthcare provider billing so that charges on a consolidated statement may be organized according to each episode of care identifier. When the monthly statement is generated, the charges on the statement are grouped according to identifiers for episodes of care rather than chronologically, by provider, etc. As a result, it is easier for the consumer to see and understand each healthcare provider's charges for services related to a particular episode of care.

In another example embodiment, consumers may take advantage of a financing option. A line of credit is established for the consumer and payments are made to healthcare providers using the line of credit. The consolidated statement indicates clearly the amount applied to the line of credit and the amount of the payment due for the month. The consolidated statement further indicates the remaining balance for the line of credit. For many consumers, the financing option facilitates budgeting and planning for large or ongoing medical expenses.

The consolidated billing statement clearly presents the consumer's financial responsibility to all healthcare providers for all service charges incurred during a billing cycle. The consumer makes a single payment to the financial intermediary based on the amount shown in the consolidated billing statement. The financial intermediary then makes payments to healthcare providers according to the requirements of the health plan. The financial intermediary simplifies fulfillment of the consumer's financial responsibility under a health plan for the consumer as well as the healthcare provider.

### BRIEF DESCRIPTION OF THE DRAWINGS

FIG. 1 is a first architecture diagram for a financial intermediary for electronic health claims processing according to a first example embodiment;

FIG. 2 is a second architecture diagram for a financial intermediary for electronic health claims processing according to a second example embodiment;

FIG. 3 illustrates aggregation of medical events for consolidated billing according to an example embodiment;

FIGS. 4A-4C present a first sample consolidated statement according to a first example embodiment; and

FIGS. 5A-5C present a second sample consolidated statement according to a second example embodiment.

### DETAILED DESCRIPTION

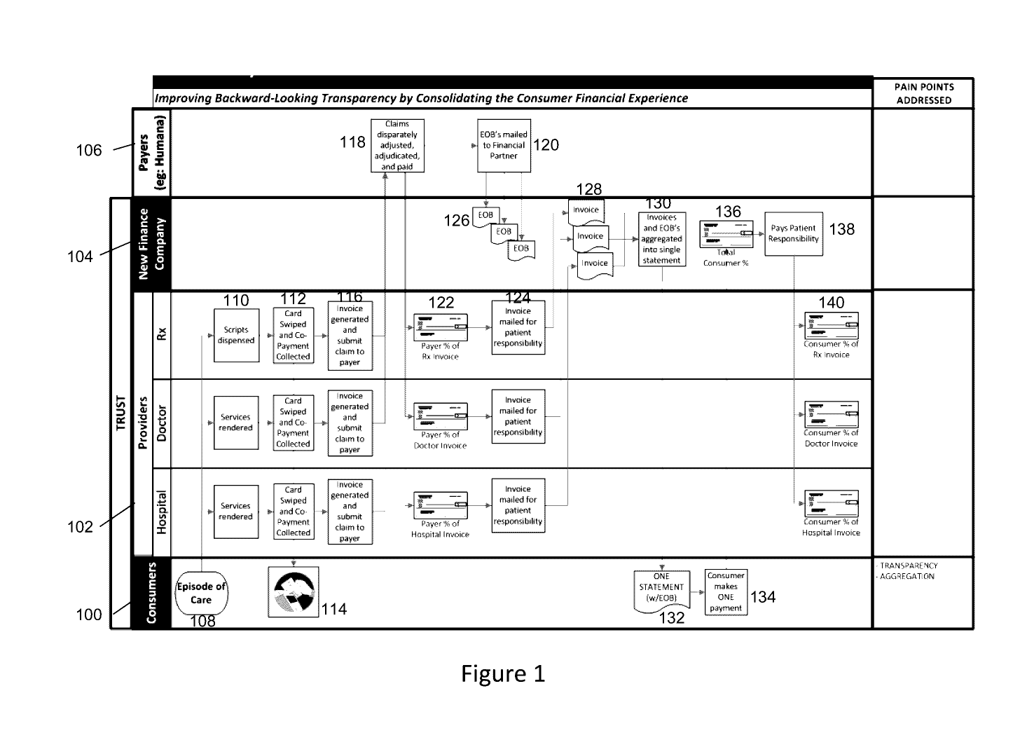

Referring to FIG. 1, a first architecture diagram for a financial intermediary for electronic health claims processing according to a first example embodiment is shown. In this example embodiment, charges for healthcare services from multiple healthcare providers are consolidated on a single billing statement. As indicated in FIG. 1, the parties involved in claim processing include a member of a health plan 100 (i.e., consumer), one or more healthcare providers 102 (e.g., hospitals, doctors, and pharmacies), a financial intermediary 104, and a payer 106 (e.g., insurer or other health benefits provider). Each episode of care 108 that a member may have involves one or more services or prescriptions 110 provided by one or more healthcare providers 102 (hospitals, doctors, and pharmacies). The member's health or medical benefits card is swiped 114 at the provider's facility at the time of service to collect member identifying data, health plan data, and other data needed to process a claim and if applicable, a co-payment required under the member's health plan 112. Alternatively, cardholder instructions for payment are manually gathered and billing records are updated. Each healthcare provider then generates an invoice for the service 116 and submits it to the payer 106.

As the provider claims arrive at the payer 106, they are disparately adjusted, adjudicated, and paid according to the benefits under the member's health plan 118. The payer pays each healthcare provider invoice according to its financial obligations under the health plan 122 and transmits EOBs 120 to the financial intermediary 104. The healthcare providers generate and transmit invoices for patient responsibility 124 to the financial intermediary 104 for any unreimbursed portion of the invoice for which the member is responsible.

The financial intermediary 104 reviews the EOBs 126 from the payer 106 and the invoices 128 from the healthcare providers 102 and aggregates the data from the payer 106 and the providers 102 to generate a single statement with all charges from the providers 130. Healthcare provider electronic invoice data and EOB data may be stored in one or more databases and then retrieved for processing. In an example embodiment, the EOBs and invoices are matched based on identifying data (e.g., healthcare provider, description of service, date of service, etc.). From the EOBs, the member's financial responsibility for each invoice is determined and a total amount owed to healthcare providers is calculated. A single statement with healthcare provider invoice charges and payer EOBs as well as the total amount owed is sent to the member 132. The member makes a single payment 134 to the financial intermediary 104. The member's payment is applied to the provider invoices 136 and the financial intermediary pays each provider 138 according to the member's financial obligations under the health plan 140.

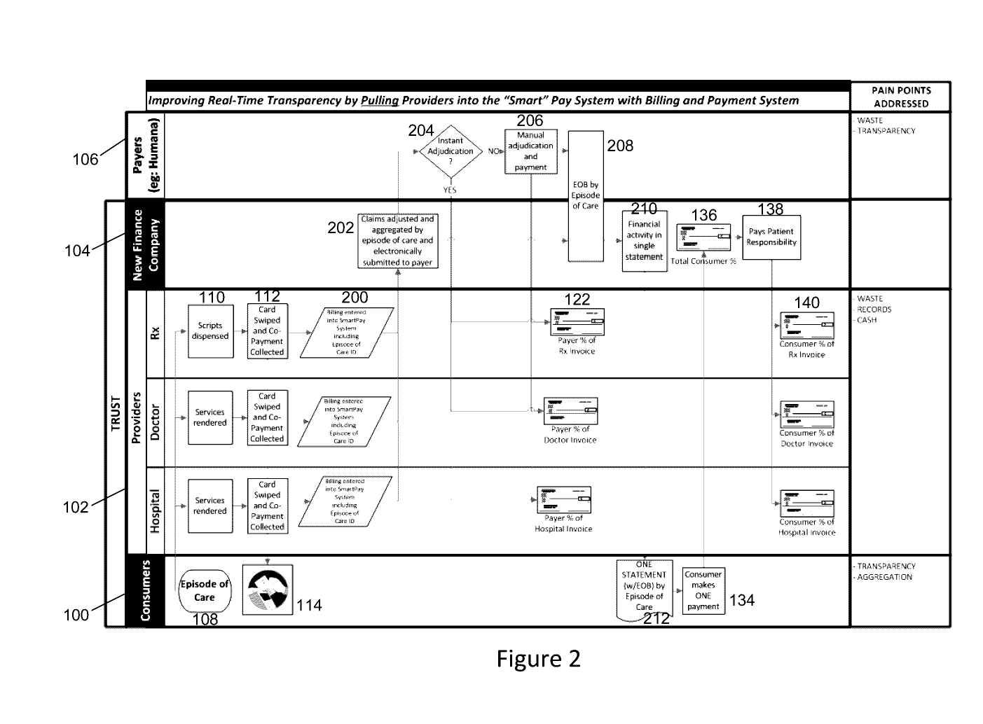

Referring to FIG. 2, a second architecture diagram for a financial intermediary for electronic health claims processing according to a second example embodiment is shown. In this example embodiment, charges for healthcare services from multiple healthcare providers are aggregated according to an episode of care and consolidated on a single billing statement. As with the embodiment shown in FIG. 1, the parties involved in claim processing include a member of a health plan 100 (i.e., consumer), one or more healthcare providers 102 (e.g., hospitals, doctors, and pharmacies), a financial intermediary 104, and a payer 106 (e.g., insurer or other health benefits provider). Each episode of care 108 that a member has involves one or more services 110 provided by one or more healthcare providers 102 (hospitals, doctors, and pharmacies). The member's health or medical benefits card is swiped 114 at the healthcare provider's facility at the time of service to collect member identifying data, health plan data, and other data needed to process a claim and if applicable, a co-payment required under the consumer's health plan 112. Alternatively, cardholder instructions for payment are manually gathered and billing records are updated. Each provider then enters billing data to a payment system 200 and submits it to the payer 106.

The billing data entered in the payment system comprises an episode of care identifier to facilitate tracking of invoices and payments according to episodes of care. The payment system captures the episode of care information along with the billing information and automatically creates an electronic health record that can be transferred easily to multiple providers. The episode of care identifier may be shared and attached to other records to facilitate aggregation of records according to the episode of care identifier.

At the financial intermediary 104, the claims are adjusted and aggregated according to the episode of care identifier 202 and then electronically transmitted to the payer 106. Each group of aggregated claims may be instantly adjudicated by the payer 204. Following adjudication of claims that are subject to instant adjudication, each provider is paid 122 according to the payer's financial obligations under the health plan. Claims that are not subject to instant adjudication are manually adjudicated 206, and following manual adjudication, a payment is made to each provider according to the payer's financial obligations under the health plan 122.

Additionally, the payer 106 provides EOBs organized according to the episode of care identifiers 208. The financial intermediary 106 generates a single statement with healthcare provider invoices and EOBs organized according to episodes of care 210. Healthcare provider electronic invoice data and EOB data may be stored in one or more databases and then retrieved for processing. From the EOBs, the member's financial responsibility for each invoice is determined and a total amount owed is calculated. The statement with the invoices/provider charges, EOBs/amounts owed, and total amount owed is sent to the member 212. The member makes a single payment 134 to the financial intermediary 104. The member's payment is applied to the provider invoices 136 and the financial intermediary pays each provider 138 according to the member's financial obligations under the health plan 140.

For members that elect a financing option, payments are made to healthcare providers according to the member's financial responsibility under the health plan. The member's payment to the financial intermediary is based on the terms and conditions of the line of credit extended to the member. The member makes a single, reduced payment to the financial intermediary and eliminates the risk of missing multiple payments to multiple healthcare providers. As a result, the member's credit score is not impacted by missed payments to multiple healthcare providers.

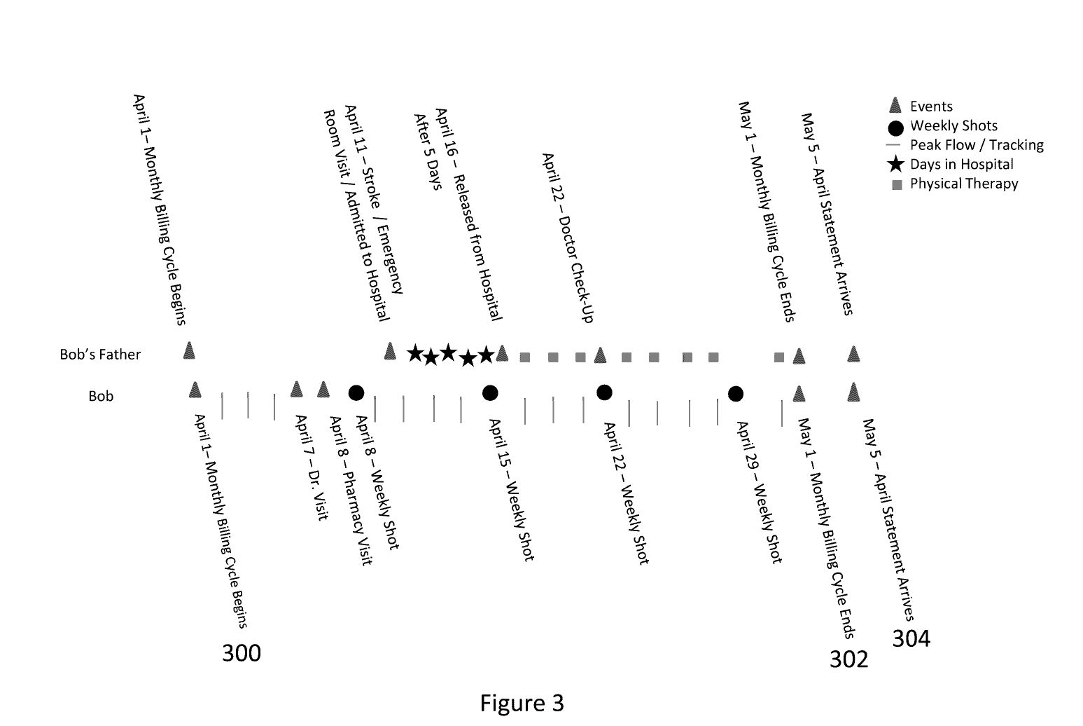

FIG. 3 illustrates aggregation of events for consolidated billing according to an example embodiment. The following assumptions apply to the events shown in FIG. 3. A consumer/caregiver, Bob Smith, Jr., is 52 years old, married, and has two children. His family is important to him. He and his wife work. Bob is a college graduate, English is his primary language, and he is computer-savvy but not very involved in social media. He spends time indoors for his career and workouts and spends time outdoors engaged in activities with his family.

Bob's health overall is good but he has chronic asthma so he struggles with shortness of breath. He is concerned with his health and has annual physicals and check-ups, routinely reviews his health account information (e.g., health savings account or flexible spending account), and routinely exercises and walks. He is also a caregiver to his father, Robert Smith, Sr. He is not a risk taker but he is a planner and is very responsible. His current health scenarios are as follows:

TABLE 1
Consumer/Caregiver Bob Scenarios

| | |
|---|---|
| Strep Throat | Doctor appointment |
| | Strep test |
| | Prescription |
| Allergies | Weekly doctor visit |
| | Allergy shot |

Robert Smith, Sr. is 82 years old and he lives in an assisted living facility. He remains devoted to his wife who passed away recently. He is a high school graduate and has had some memory loss. English is his primary language but it is difficult to understand him. He worked as a laborer and provider and has not been a risk taker. He has no computer skills and is not interested in technology. He spends most of his time indoors with little outside activity. He also has had Parkinson's disease for about eight years. He recently had a stroke and is undergoing physical therapy. Bob manages his father's healthcare bills. Bob's father's current health scenarios are as follows:

TABLE 2
Consumer/Caregiver Bob's Father's Scenarios

| | |
|---|---|
| Monthly | RM |
| Activities/Expenses | Food |
| | Medications |
| | Check-ups |
| | Physical therapy for recent stroke |
| | Entertainment |
| | Biometric screening |
| Chronic Illness | Parkinson's disease |
| Stroke | Hospital stay |
| | Tests/labs |
| | Specialists |
| | Medications |
| | Ambulance |
| Nursing Home | Room/board/general care |
| | Physical therapy |
| | Medications |
| | Check-ups |

As indicated in the timeline of FIG. 3, during a one month period that begins on the first of the month 300 and ends on the last day of the month 302, each individual covered under a single health plan may experience a plurality of “medical events” related to their personal health problems that result in charges for services from one or more healthcare providers. In the example directed to Bob and his father, there are several medical events shown in FIG. 3. Bob's chronic asthma condition may require weekly shots (April 8, April 15, April 22, and April 29) and a refill of asthma medications (April 8). In addition, monitoring of Bob's condition is important so his peak flow may be checked numerous times during the month. Unexpected events may also occur such as a visit to a doctor's office for strep throat (April 7 and 8).

Robert Smith, Sr.'s stroke resulted in an ambulance ride and admission to the hospital on April 11 followed by a five-day stay. While in the emergency room, charges are incurred for tests, x-rays, and specialist consultations. Following the hospital stay, charges are incurred for each physical therapy session as well as for medications and doctor visits. As FIG. 3 illustrates, during a one month period, two individuals covered under a single health plan may incur numerous charges from multiple healthcare providers for medical events related to chronic as well as acute health conditions. Rather than receive EOBs from a payer and separate invoices from each healthcare provider following adjudication of claims, the events and charges for the month may be consolidated on a single billing statement from a financial intermediary. The statement provides a clear indication of the consumer's responsibility, if any, related to each event so the consumer is clear about his or her financial responsibilities to all of the healthcare providers. The consumer may then make one payment according to the information from the billing statement and the financial intermediary distributes payments to the individual healthcare providers according to the requirements of the health plan.

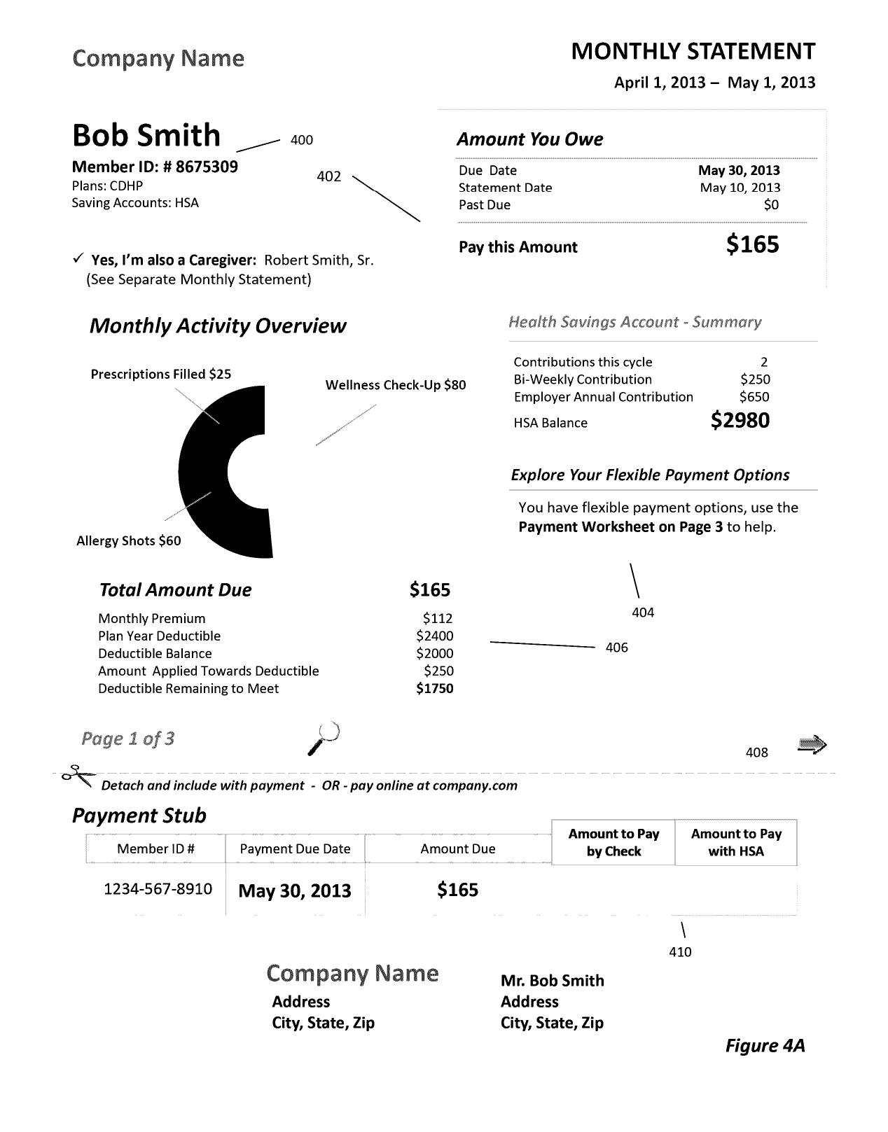

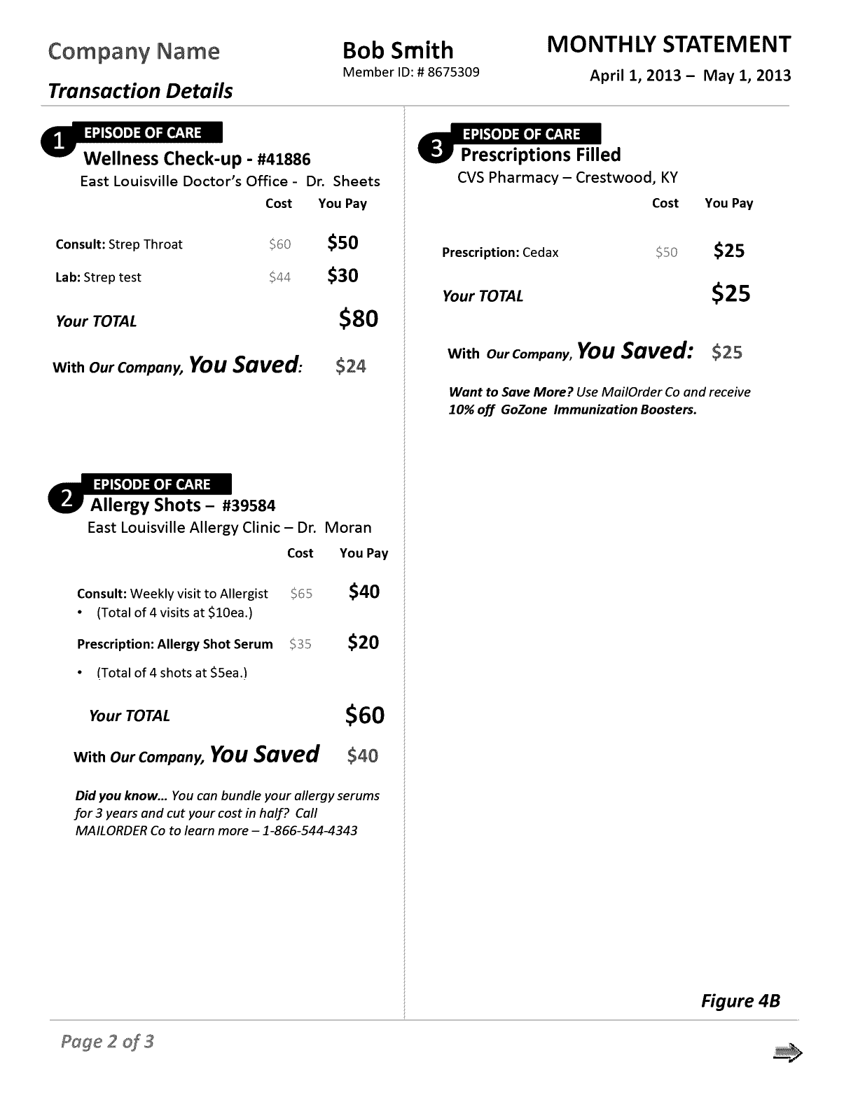

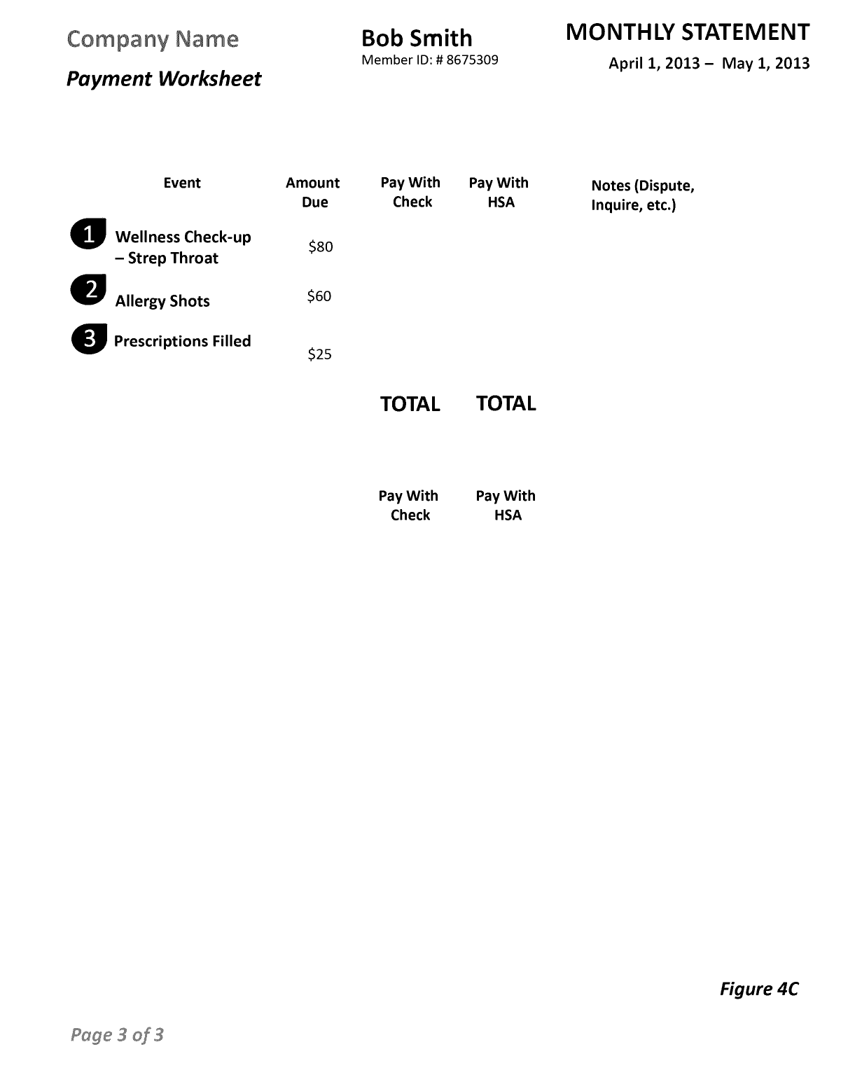

Referring to FIGS. 4A-4C, a first sample statement according to a first example embodiment is shown. Referring to FIG. 4A, in an example embodiment, a monthly statement comprises member and health plan identifying data 400, an amount due to the financial intermediary 402, a health benefits account (e.g., health savings account) summary 404, and an activity overview 406. The statement may further comprise a payment stub with the amount due 408. The payment stub may further comprise a payment option section 410 with payment options such as pay by check or pay with funds from a health savings account. When the member's payment is received, the payment system at the financial intermediary may be updated to reflect the amount of member's payment and whether the member paid by check or with funds from a health savings account. Members may have the option of paying online or returning the payment stub with an election of a payment option (e.g., check or health savings account).

Referring to FIG. 4B, the statement may further comprise episode of care data. Each episode of care is assigned an identifier (e.g., 41886, 39584, etc.) and for each episode of care, the related transactions are listed. Each episode of care indicates clearly the individual and total charges associated with the event.

Referring to FIG. 4C, the statement may also comprise a worksheet to facilitate tracking of payments. The member may complete worksheet and indicate for each episode of care whether payment was made with a check or with a health benefits account.

In an example embodiment, separate statements may be generated for each individual covered under a health plan. Organization of claims and billing data according to patient, as well as amounts owed to healthcare providers, may facilitate the member's budgeting and planning for expenses.

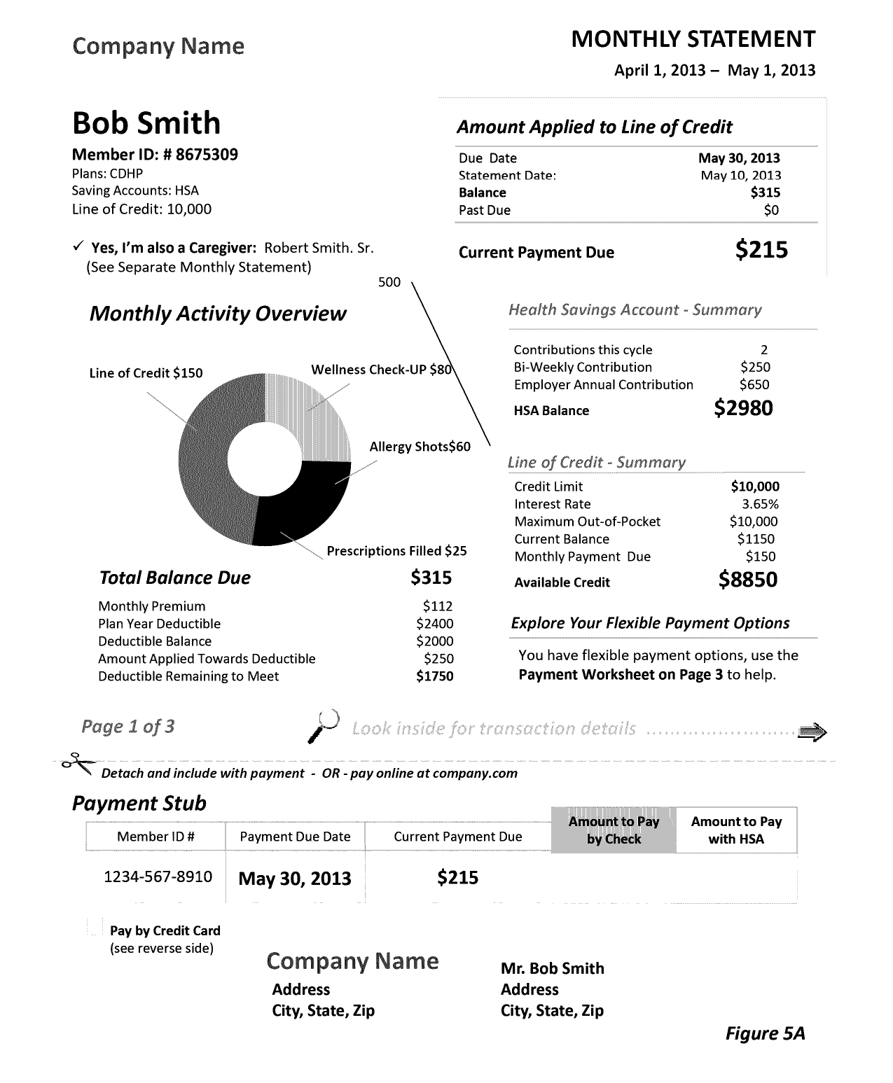

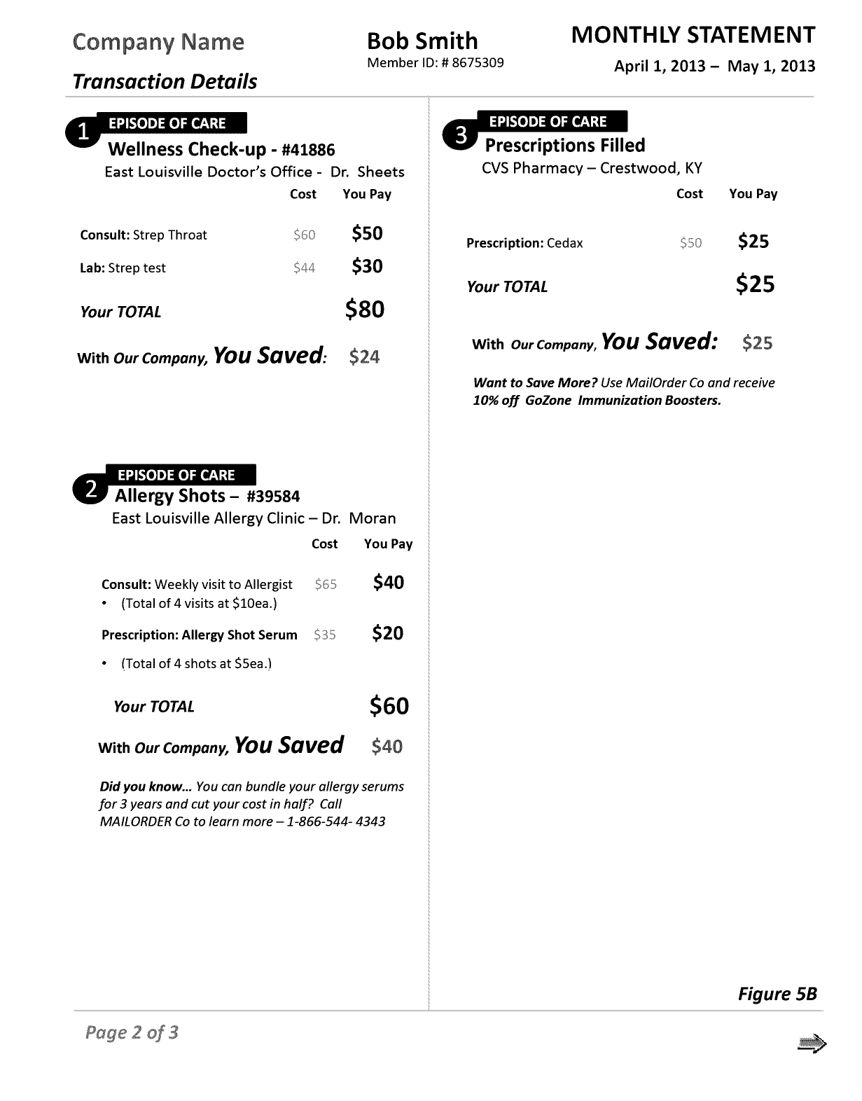

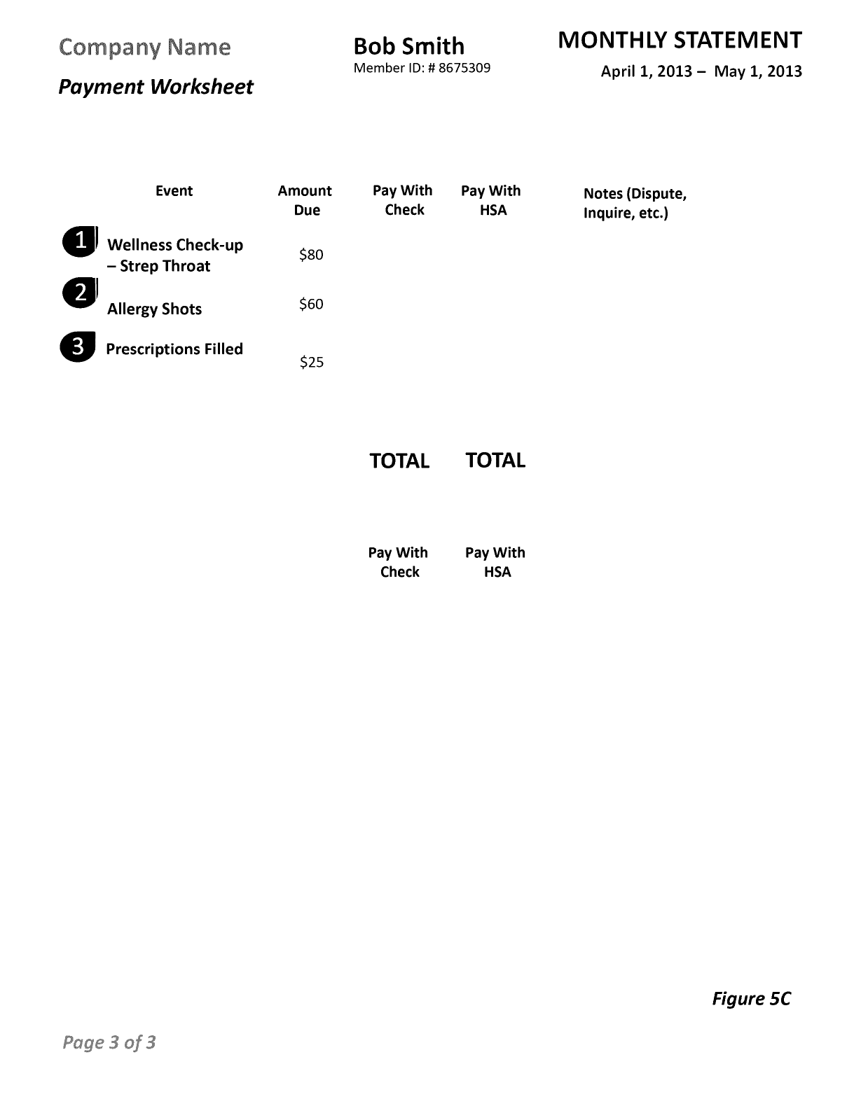

Referring to FIGS. 5A-5C, a second sample statement according to a second example embodiment is shown. Referring to FIG. 5A, a monthly statement with details related to a line of credit is shown. In addition to the information presented on the statement of FIG. 4A, the statement comprises a line of credit summary section 500. The section presents details such as the member's credit limit, interest rate, maximum out-of-pocket limit, current balance, monthly payment due, and available credit. A financing option allows the member to make payments on large expenses over time to help budgeting and planning. For members that elect a financing option, the confusion and threat of accumulating medical bills is eliminated. Healthcare providers also benefit from the financing option by receiving payment immediately and avoiding administrative costs associated with collections.

The introduction of a financial intermediary into electronic health claims processing results in numerous benefits not only to consumers but to payers and providers. Benefits are summarized in the following table.

TABLE 3
Benefits of a Financial Intermediary and Consolidated Billing

| Benefits | | | |
|---|---|---|---|
| Summary | Health Plan Member | Payer | Provider |
| Easy to | Eliminates the multiple EOBS | Fewer customer service calls | Fewer questions |
| Understand | and bills from various | regarding billing confusion. | regarding what services |
| Billing | healthcare providers and | Quicker payment made by | were performed or what |
| | vendors and compiles them | the member | is included in a bill. |
| | into one easy understand | | |
| | statement. | | |
| | Items on statement are tied to | | |
| | a single episode of care. | | |
| | Easy to understand amount | | |
| | that is owed. | | |
| One | One single statement a month | No need to generate nearly | Bill more likely to be |
| Consolidated | to monitor, instead of multiple | as many mailings. | paid. |
| Statement | bills and EOBS from multiple | Combine EOB's and billings | |
| | providers. | into one. | |
| | Saves time. | | |
| Eliminates | No need to decipher multiple | Cost saving from reduced | Savings from no longer |
| Multiple | mailings. | postage and reduced internal | direct billing members. |
| Mailings | One, easy statement to | effort to produce multiple | |
| | monitor. | mailings. | |
| Ease of Payment | One statement means one | Receive payments earlier | Receive payment |
| | payment and financing | | earlier. |
| | options are available. | | Collection rates will |
| | No need to deal with separate | | increase. |
| | copays and payments at | | |
| | every provider. | | |
| Reduce Office | Improved customer service | Eliminates internal effort from | Administrative tasks |
| Inefficiencies | from provider staff freed from | producing multiple mailings. | such as billings and |
| | administrative tasks. | Reduced customer service | collections shift to |
| | | needs. | financial intermediary. |
| Creation of | System captures Episode of | The system automatically | An easy to use |
| Electronic | Care information along with | creates an electronic health | electronic health record |
| Health Record | billing info. | record, at no additional cost, | is generated for their |
| | This automatically creates an | a massive savings over | use at no additional |
| | electronic health record that | current efforts to launch such | cost to them. |
| | can be transferred easily to | systems. | |
| | multiple providers. | | |
| Financing | Provides the option to make | Can collect fees and interest | Can receive payment |
| Options | payments on large items over | related to providing financing | immediately; eliminates |
| | time to help budgeting and | to both members and | collections overhead. |
| | planning purposes. | providers. | |
| Consumerism | Armed with the knowledge of | Members will be more cost | Member will be able to |
| Enabled | the true cost and value of | conscious and that will | more fully engage |
| | their care, member can make | ultimately lead to more | providers and become a |
| | informed decisions on | efficient use of the healthcare | partner in decision |
| | treatment. | system. | making. |

While certain embodiments of the disclosed financial intermediary for electronic health claims processing are described in detail above, the scope of the invention is not to be considered limited by such disclosure, and modifications are possible without departing from the spirit of the invention as evidenced by the claims. For example, elements of medical event consolidation and defining episodes of care may be varied and fall within the scope of the claimed invention. Various aspects of statement generation and layout may be varied and fall within the scope of the claimed invention. One skilled in the art would recognize that such modifications are possible without departing from the scope of the claimed invention.

What is claimed is:

1. A system for providing consolidated healthcare billing statements with charges grouped by episode of care comprising:
a first database comprising healthcare provider invoice data from a plurality of healthcare providers, said healthcare provider invoice data comprising for each invoice:
a healthcare provider identifier;
a healthcare service identifier for at least one healthcare service provided by said healthcare provider; and
a date of service corresponding to the healthcare services provided;
a second database comprising explanation of benefits data for a plurality of electronic healthcare claims from said plurality of healthcare providers for a member covered by a health plan, said explanation of benefits data comprising for each electronic healthcare claim:
a healthcare provider identifier;
a healthcare service identifier for at least one healthcare service provided by said healthcare provider;
an explanation of benefits; and
an amount owed by said member to said healthcare provider based on a charge in said electronic healthcare claim and benefits under said health plan;
a computer server;
software instructions that when executed by the computer server configure the computer server to:
receive a date range defining a billing cycle;
receive a member identifier identifying a member covered by the health plan;
receive from the first database, invoice data from the plurality of healthcare providers with dates of service occurring within the received date range where the invoice data represents invoices generated as the result of services provided to the identified member;
identify one or more episodes of care received by the identified member during the received date range and assign a unique identifier to each episode of care;
sort the invoice data into groups defined by the one or more episodes of care provided to the identified member;
receive from the second database, benefits data for the plurality of healthcare claims from the plurality of healthcare providers;
match the received benefits data with the sorted invoice data;
For each identified episode of care:
calculate from the received invoice data an amount billed for each service provided during the episode of care; and
determine an amount billed by the provider for each service provided during the episode of care;
calculate an amount due for each episode of care after the application of payments described in the benefits data;
calculate a total amount due by summing the calculated amounts due for all episodes of care;
generate a consolidated bill for the identified member comprising a listing of each identified episode of care and further comprising:
a description of the episode of care;
a listing of the charges billed by each provider for the episode of care;
a listing of the charges billed by each provider after the application of payments described in the benefits data;
an amount due for each said episode of care;
a total amount due; and
at least one message related to improving the health of the member.

2. A system for providing consolidated healthcare billing statements with charges grouped by episode of care comprising:
healthcare provider invoice data from a plurality of healthcare providers;
explanation of benefits data for a plurality of electronic healthcare claims from said plurality of healthcare providers for a member covered by a health plan;
a computer server;
software instructions that when executed by the computer server configure the computer server to:
receive a member identifier identifying a member covered by the health plan;
receive invoice data from the plurality of healthcare providers with dates of service occurring within a billing cycle where the invoice data represents invoices generated as the result of services provided to the identified member;
sort the invoice data into groups defined by the one or more episodes of care provided to the identified member;
receive benefits data for the plurality of healthcare claims from the plurality of healthcare providers;
calculate an amount due for each episode of care after the application of payments described in the benefits data;
calculate a total amount due by summing the calculated amounts due for all episodes of care; and
generate a consolidated bill for the identified member comprising a listing of each identified episode of care and the calculated amount due for each episode of care and the total amount due.

3. The system of claim 2 further comprising software instructions that configure the processor to receive a date range defining the billing cycle.

4. The system of claim 2 further comprising a first database which comprises the received invoice data and a second database which comprises the received explanation of benefits data.

5. The system of claim 2 wherein the software instructions further configure the computer server to match the received explanation of benefits data with the sorted invoice data.

6. The system of claim 2 where the healthcare provider invoice data comprises for each invoice:
a healthcare provider identifier;
a healthcare service identifier for at least one healthcare service provided by said healthcare provider; and
a date of service corresponding to the healthcare services provided.

7. The system of claim 2 where explanation of benefits data comprises for each electronic healthcare claim:
a healthcare provider identifier;
a healthcare service identifier for at least one healthcare service provided by said healthcare provider;
an explanation of benefits; and
an amount owed by said member to said healthcare provider based on a charge in said electronic healthcare claim and benefits under said health plan paid to the healthcare provider.

8. The system of claim 2 where the software instructions further comprise instructions to configure the computer server to identify one or more episodes of care received by the identified member during a date range and assign a unique identifier to each episode of care.

9. The system of claim 8 wherein the unique identifier is a description of the care received by the identified member.

10. The system of claim 8 wherein the unique identifier comprises healthcare provider information for a provider who supplied healthcare for the episode of care.

11. The system of claim 2 wherein the software instructions further comprise instructions to configure the computer server to calculate for the received invoice data for each identified episode of care an amount billed for each service provided during the episode of care and to determine an amount billed by the provider for each service provided during the episode of care.

12. The system of claim 2 wherein the generated bill further comprises:
a description of the episode of care;
a listing of charges for the episode of care;
a listing of the charges billed by each provider for the episode of care;
a listing of the charges billed by each provider after the application of payments described in the explanation of benefits data; and
an amount due for each said episode of care.

13. The system of claim 12, wherein the generated bill further comprises a total amount due.

14. The system of claim 12, wherein the generated bill further comprises a summary of a health savings account balance for the identified member.

15. The system of claim 12, wherein the generated bill comprises a payment worksheet which further comprises entry fields for a plurality of payment methods.

16. The system of claim 12, wherein the payment fields are organized by episode of care.

17. The system of claim 12, wherein the plurality of payment methods includes a heath savings account.

18. The system of claim 12 wherein the generated bill further comprises a summary of care activity during the date range.

19. The system of claim 2, wherein the generated bill comprises at least one message related to improving the health of the member.

20. A method of generating healthcare billing statements with charges grouped by episode of care comprising the steps of:
receiving healthcare provider invoice data from a plurality of healthcare providers;
receiving benefits data for a plurality of electronic healthcare claims from said plurality of healthcare providers for a member covered by a health plan;
configuring a computer server to:
receive a member identifier identifying a member covered by the health plan;
receive invoice data from the plurality of healthcare providers with dates of service occurring within a billing cycle where the invoice data represents invoices generated as the result of services provided to the identified member;
identify one or more episodes of care received by the identified member during the billing cycle and assign a unique identifier to each episode of care;
sort the invoice data into groups defined by the one or more episodes of care provided to the identified member;
receive benefits data for the plurality of healthcare claims from the plurality of healthcare providers;
For each identified episode of care:
calculate from the received invoice data an amount billed for each service provided during the episode of care; and
determine an amount billed by the provider for each service provided during the episode of care;
calculate an amount due for each episode of care after the application of payments described in the explanation of benefits;
calculate a total amount due by summing the calculated amounts due for all episodes of care during the billing cycle;
generate a consolidated bill for the identified member comprising a listing of each identified episode of care and further comprising:
a description of the episode of care;
a listing of the charges billed by each provider for the episode of care;
a listing of the charges billed by each provider after the application of payments described in the explanation of benefits;
an amount due for each said episode of care;
a total amount due; and
at least one message related to improving the health of the member.

21. The method of claim 20 further comprising the step of configuring the processor to receive a date range defining the billing cycle.

22. The method of claim 20 further comprising matching the received benefits data with the sorted invoice data.

23. The method of claim 20, where the step of generating a consolidated bill comprises the step of listing a total amount due.

24. The method of claim 20, where the step of generating a consolidated bill comprises the step of generating a payment worksheet which further comprises entry fields for a plurality of payment methods.

25. The system of claim 20 wherein the description of the episode of care comprises healthcare provider information for a provider who supplied healthcare for the episode of care.
